(19) United States
(12) Patent Application Publication
(10) Pub. No.: US 2015/0194063 A1
(43) Pub. Date: Jul. 9, 2015

(54) SYSTEMS AND METHODS FOR MEASURING THE EFFECTIVENESS OF VERBAL AND NONVERBAL COMMUNICATION SKILLS VIA PEER REVIEWS

(71) Applicant: Vlinks Media, LLC, Chicago, IL (US)

(72) Inventors: Ethan Linkner, Chicago, IL (US); Vishal Shah, Chicago, IL (US); Ryan Leavitt, Chicago, IL (US)

(73) Assignee: Vlinks Media, LLC

(21) Appl. No.: 14/578,338

(22) Filed: Dec. 19, 2014

Related U.S. Application Data
(60) Provisional application No. 61/924,214, filed on Jan. 6, 2014.

(51) Int. Cl. G09B 5/06; G09B 7/00; G06Q 10/06

(52) U.S. Cl. CPC G09B 5/06; G06Q 10/0639; G09B 7/00

(57) ABSTRACT

The present disclosure provides a system and method for interactive communication skill training and evaluation. The system provides a quantitative assessment of an individual's verbal and nonverbal communication skills by incorporating a software platform comprising personal audiovisual recordings and peer evaluations. The system may uncover a skill gap between knowledge and performance as it relates to a defined communication goal.

### CROSS-REFERENCE TO RELATED APPLICATIONS

This application incorporates by reference and claims the benefit of priority to U.S. provisional Application 61/924,214 filed Jan. 6, 2014.

### BACKGROUND OF THE INVENTION

The present subject matter relates generally to training and evaluating verbal and nonverbal communication skills of individuals via an interactive educational skills training tool.

Evaluating employees' verbal and nonverbal communication skills is critical to the success of organizations within today's modern global economy. To remain competitive, companies must retain employees who are knowledgeable in the company's area of expertise and are able to clearly communicate such knowledge to customers as well as internally to the organization. Companies need a system for assessing and improving the effectiveness of employees' communication relating to, for example, the company's goods, services, value, and having monitoring for internal leadership and management to ensure employees obtain and maintain such skills.

It is imperative that organizations be able to immediately train their employees to keep up with the fast pace of innovation. For example, companies must continuously accelerate the time to introduce a product or service to market. A drawback of conventional training systems is the time required to implement a training program to its employees about a new product or service. Typically, the company must organize a meeting for an entire group of employees, which requires, among many other expenses, that the company take into account each individual's schedule and prior commitments, prepare the materials, find a venue, and conduct the seminar to convey new information to the employees.

Further, conventional training and evaluation programs fail to provide an opportunity for the employee to actively practice, review, and receive critique on his or her verbal and nonverbal communication. Most employee training is in the form of lectures and presentations, where participants sit back passively absorbing knowledge, rather than in formats customized for each employee. Currently, to review and critique an employee's communication skills, an employer needs to schedule a time that works for both parties. However, such review process is inconvenient and inefficient. Further, having only one party, as opposed to a pool of reviewers, review and evaluate the employee's presentation creates subjective results.

In addition, many conventional evaluation methods fail to allow the ability for executives to monitor employee performance using meaningful metrics. The inability to accurately monitor performance metrics results in an inability to ensure employee quality, provide accurate resource forecasts, accurately allocate costs, and provide a means to ensure learning success.

Due to the lack of meaningful metrics for an employer's review of an employee's performance, as well as the reliance on live reviews, employers and employees often cannot view or compare historical evaluations relating to a certain employee. As such, both the employer and employee are unaware of those areas of communication in which the employee needs improvement, how an employee has improved or suggestions on how and employee can improve them. In addition, the employer cannot accurately compare employees to each other because of the lack of meaningful evaluation metrics.

In addition, conventional employee training is cost prohibitive, resource intensive, disorganized, not easily scalable within an organization, and leads to inconsistent results. Typically, companies match senior employees as trainers with junior employees as trainees. However, one-on-one training requires an enormous amount of effort and diverts senior employees from their hired purposes, undermining company productivity. Further, one-on-one training results in inconsistent training methods and creates employees with varying degrees of competence. Other training is conducted with employees sharing their recordings via email, or even leaving voicemails. This is a disorganized process with minimal accountability and tracking.

Mass trainings, such as seminars and summits, may create a more unified work force, but such events are often expensive and allow individuals struggling with the material to fall through the cracks. Companies must often pay for airfare, lodging, ground transportation, meals, and entertainment during training seminars for each employee. Further, because of the lack of individual attention and feedback, many employees who do not understand the training material are never identified for purposes of further training.

As such, there is a need for a training and evaluation systems and methods that provide organizations with a meaningful and efficient platform for teaching, training, and evaluating the verbal and nonverbal skills of its employees, wherein the evaluation process includes peer review.

### BRIEF SUMMARY OF THE INVENTION

The present disclosure provides systems and methods for measuring verbal and nonverbal skills of individuals. Various examples of the systems and methods are provided herein. Although throughout the specification an employee-employer example is used, the systems and methods disclosed herein may be used with any group of individuals.

The present disclosure provides a system and method that provides a quantitative assessment and recommendations for improvement of the effectiveness of an individual's communication and presentation skills. The method may include soft skill building, software proficiency (screen capture), writing ability or demonstrating ability via a software platform comprising personal audiovisual recordings and peer evaluations. The system may uncover a skill gap between knowledge and performance as it relates to a defined pitch goal. In addition, the system may define a baseline in soft-skills using peer feedback to help share knowledge and increase performance.

Specifically, the method and system disclosed herein for measuring the effectiveness of verbal and non-verbal communication includes the use of peer reviews and self-evaluations to score communications related to a pitch goal established by a group leader. A pitch goal is any assignment or activity for a peer (employee) to respond to via the platform. For example, a pitch goal may be an assignment for a peer to record a communication.

Once the pitch goal is created, the group leader creates a group of one or more peers and assigns a course including the pitch goal for completion. In an example, each peer within the group must record his or her own peer recording and also evaluate the peer recordings of all the other members of the group. If the pitch goal is time sensitive, an optional due date may be included within the course. With the pitch goal established and the peer group selected, the group leader formally assigns the pitch goal to a peer group.

Upon assignment, all assigned peers receive notification of the pitch goal for completion in a pitch module. Typically, all submitted pitches are reviewed and scored by the group leader(s) along with an optional panel of peers or experts. Note that the term peer includes individuals of equal position to the peer associated with the submitted communication, as well as individuals both in higher rank (e.g., bosses, administrators, managers, etc.) and lower in rank. Only communications that are submitted are reviewed by peers and group leaders. In other words, a peer may record or write more than one communication as self-evaluation, and the communications that are not submitted essentially remain confidential.

The system includes a pitch module, evaluation module, and a peer profile module. The pitch module may include a writing module and/or recording module for submitting a written communication and/or an audiovisual recording, respectively. For example, in the recording module, peers complete a recording of a peer audio communication, an audio and video communication, a written communication, a recording of their computer screen or screen of any device, an upload of a recording, a video recording of themselves or anything focused on addressing the pitch goal. The peer may review his or her recorded communication made in the recording module, from which the user may decide to re-record the pitch recording in the recording module. In addition, he or she can view other submitted peer recorded communication for comparison. Once the user is satisfied with his or her recorded communication, the user may then submit, using the submit module, the communication for evaluation by a group leader and/or peers. After the evaluations are complete the system notifies the user of submitted evaluations pertaining to his or her communication.

Since each communication results in at least one score and qualitative feedback, the system allows for that communications to be repeated in order to track performance of a single skill over time. Through both the qualitative coaching from managers, and repetitive practice, the system facilitates and measures the improvement of any given skill.

The following is a list of terminology used throughout this disclosure.

Communication: An audio recording, an audiovisual recording, a recording of a computer screen or screen of any device, a screen capture, a writing sample, a video recording of themselves or any combination of these focused on addressing a specific goal.

Pitch: The act of demonstrating a skill against the pitch goal; the act of creating the communication.

Pitch Goal: An established directive and reason for the communication established by a group leader. Examples of pitch goals include: give the company elevator pitch, present a sales deck, write a cold prospect email, use Microsoft Excel's pivot table functionality, sing the national anthem, and demonstrate the sign-language alphabet.

Group: A private group of one or more peers who share a specific course, pitch goal, and due date.

Course: A set of training directives including a pitch goal for a particular group.

Group Leader: The person within the group who creates, assigns, and manages the pitch goal for assessment. In a business setting, this person would be the boss, administrator, or some other group leader.

Peer: Member of a group who delivers and/or evaluates pitches.

Panel: A selected group of peers (e.g., group leader and/or peers) used for scoring pitches.

Verbal and Non-Verbal Communication: All audio and/or visual communication, including writing, transmitted in the system.

Due Date: The date on which a pitch must be completed.

Data: The resulting quantification of skills from any given communication and or set of communications, used in reporting.

Collateral: All promotional and non-promotional material used in connection with the pitch, including the pitch goal.

Knowledge: All factual communication associated with a peer's pitch.

Skills: The ability to use one's knowledge effectively and readily in execution or performance, including all non-factual communication associated with that peer's pitch. For example, a peer's tone, body-language, speech clarity, confidence, proficiency, enthusiasm, eye contact, grammar, sentence complexity, demonstration ability, and, ultimately, if a pitch goal was achieved.

Reviewing, Scoring, Evaluation, or Assessment: The act of giving a pitch recording a quantitative and qualitative review.

An advantage of the present system and method is providing a cost effective and efficient training and evaluation program relating to both verbal and nonverbal communication for a plurality of individuals.

A further advantage of the present system and method is providing a training and evaluation process that allows for individual feedback for each user and consistent training throughout an organization.

Another advantage of the present system and method is providing a peer review platform for a communication that allows each individual to learn from others and collectively identify examples of people with the best skills.

Additional objects, advantages and novel features of the examples will be set forth in part in the description which follows, and in part will become apparent to those skilled in the art upon examination of the following description and the accompanying drawings or may be learned by production or operation of the examples. The objects and advantages of the concepts may be realized and attained by means of the methodologies, instrumentalities and combinations particularly pointed out in the appended claims.

### BRIEF DESCRIPTION OF THE DRAWINGS

The drawing figures depict one or more implementations in accord with the present concepts, by way of example only, not by way of limitations. In the figures, like reference numerals refer to the same or similar elements.

FIG. 1 is a front view of a user interface displaying an embodiment of a pitch module, specifically a record module, wherein the display includes a description of the pitch goal, the target pitch recording time length, the number of peers that will review the pitch recording upon submission, and peer's current score received from the group leader and peers.

FIG. 2 is a front view of a user interface displaying an embodiment of a creation of a group by a group leader.

FIGS. 3A-3E are front views of a user interface displaying an embodiment of a creation of a course by a group leader.

FIG. 4 is a front view of a user interface displaying an embodiment of peer page indicating a number of pitch goals the peer needs to complete, the number of peer reviews that the peer needs to complete, the peer's average and highest scores, and a list of registered course titles in which the peer is enrolled.

FIG. 5 is a front view of a user interface displaying an embodiment of peer profile module indicating various presentations the peer needs to evaluate.

FIG. 6 is a front view of a user interface displaying an embodiment of peer profile module indicating a user score associated with a communication by the user.

FIG. 7 is a front view of a user interface displaying an embodiment of a peer profile module associated with a group leader.

FIG. 8 is a front view of a user interface displaying an embodiment of a peer profile module associated with a group leader.

FIG. 9 is a front view of a user interface displaying an embodiment of a learning module including course material.

FIG. 10 is a front view of a user interface displaying an embodiment of a evaluation module of a peer.

FIG. 11 is a front view of a user interface displaying an embodiment of a peer profile module of a group leader including peer reviews of the peers of the group associated with the group leader.

FIG. 12 is a front view of a user interface displaying an embodiment of the writing module.

FIG. 13 is a front view of a user interface displaying an embodiment of a peer profile module used for evaluation.

### DETAILED DESCRIPTION OF THE INVENTION

The system and method disclosed herein provides a quantitative and qualitative knowledge and skill-based assessment of verbal and nonverbal communication skills. The system is a cost effective and efficient use of employees' time, and may be implemented to support the objectives of a global organization.

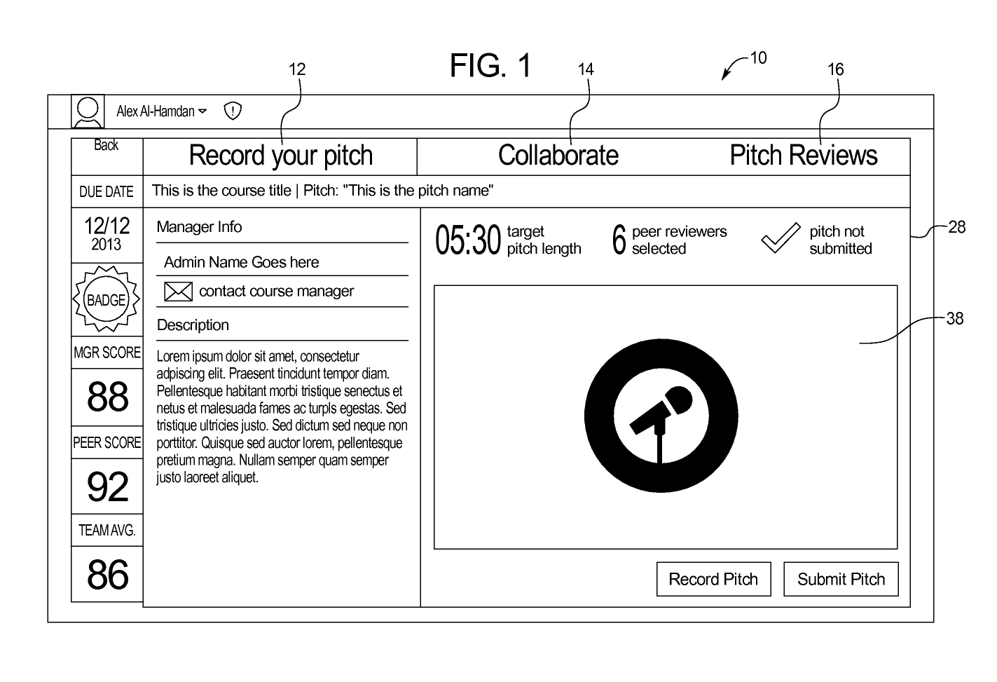

In an embodiment, the system 10 includes a pitch module 12, an evaluation module 14, and a peer profile module 16, as shown in FIG. 1. In the pitch module 12, a pitch goal 18 is created and assigned to at least one peer 22 by a group leader 24. In an example, the pitch goal 18 is assigned to a plurality of peers 22 by at least one group leader 24, who may also be a peer 22 within a group 26. Typically the group leader 24 has administrative authority within the system to create and edit the user profiles, pitch goals 18, peer groups 26, user scores, etc.

A pitch goal 18 may be any assigned communication task for which a peer 22 is to complete. For example, the pitch goal 18 may request a peer 22 to submit a communication 30 that may be audio, audiovisual, and/or textual. For example, the communication 30 may include, but not limited to, an audiovisual recording of a peer 22 presenting an elevator pitch for her company, presenting her recent research findings, performing a ten minute speech on her passions. The communication 30 may include a written text for an email pitch, a pitch slide deck, among others.

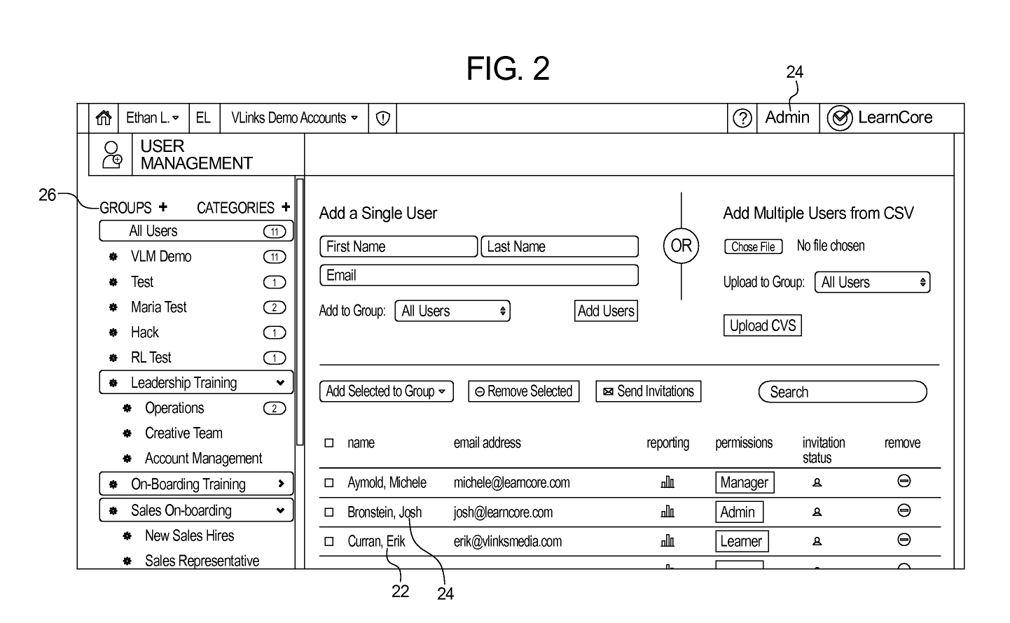

The group leader 24 may also assign the pitch goal 18 to a plurality of selected peers 22, for example, the group 26. For example, FIG. 2 illustrates a user interface 28 displaying a creation of a peer group 26 by a group leader 24. The group leader 24 may want to assign a specific pitch goal 18 to every peer 22 within an entire department of an organization.

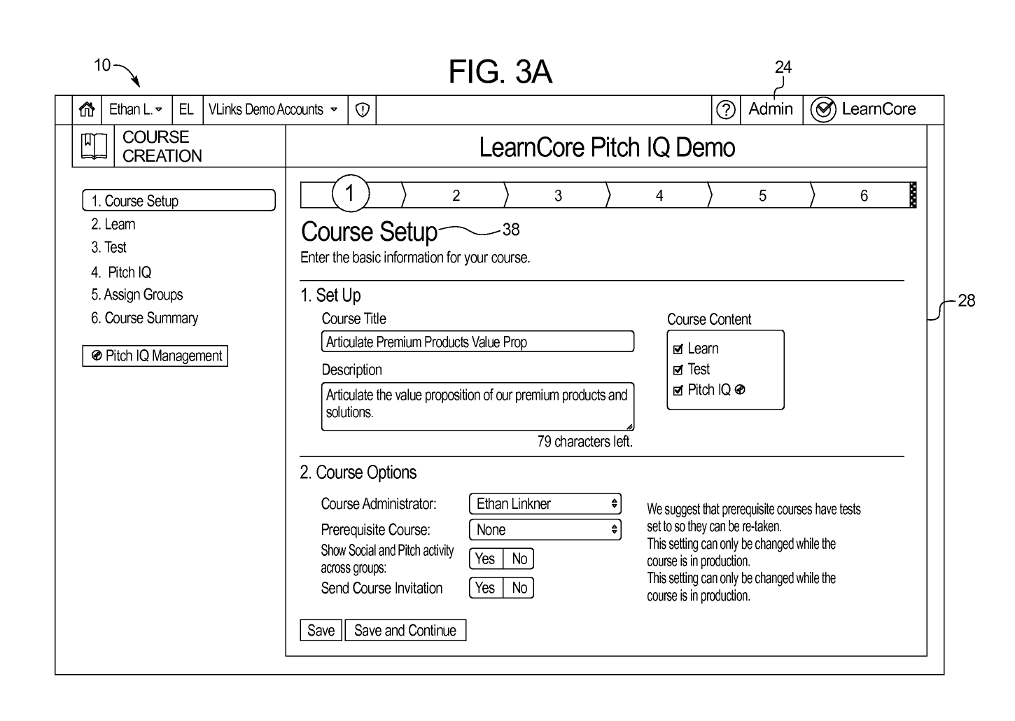

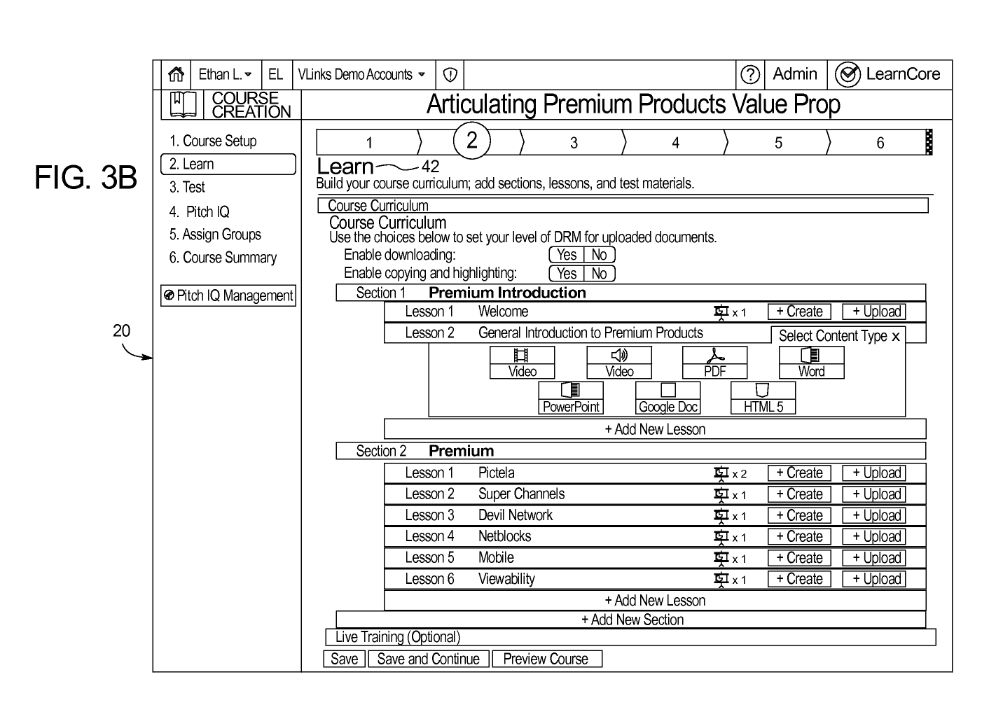

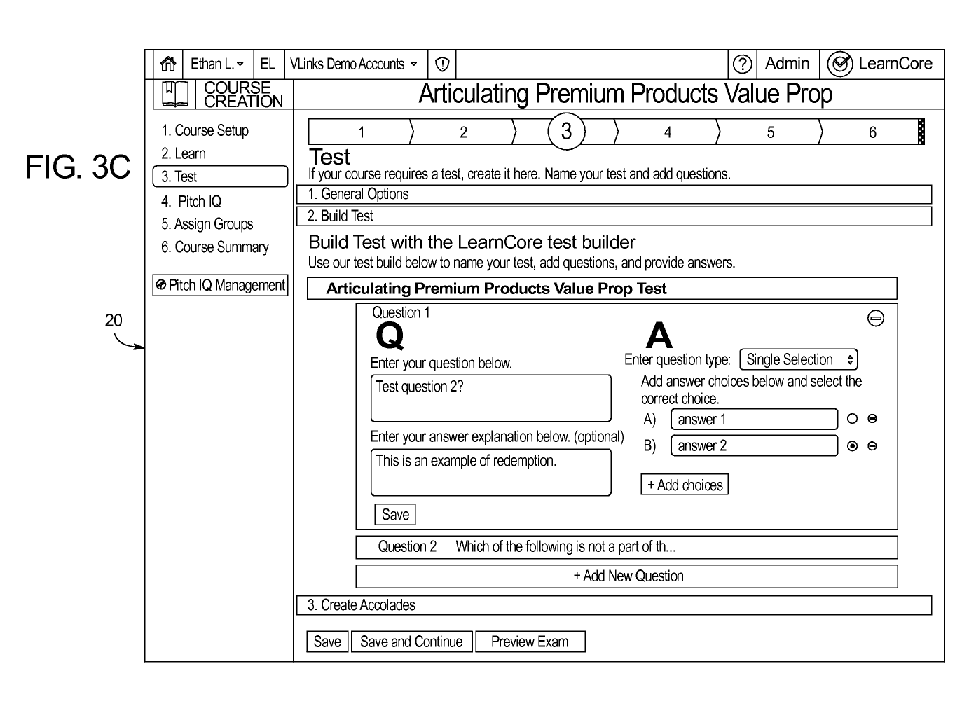

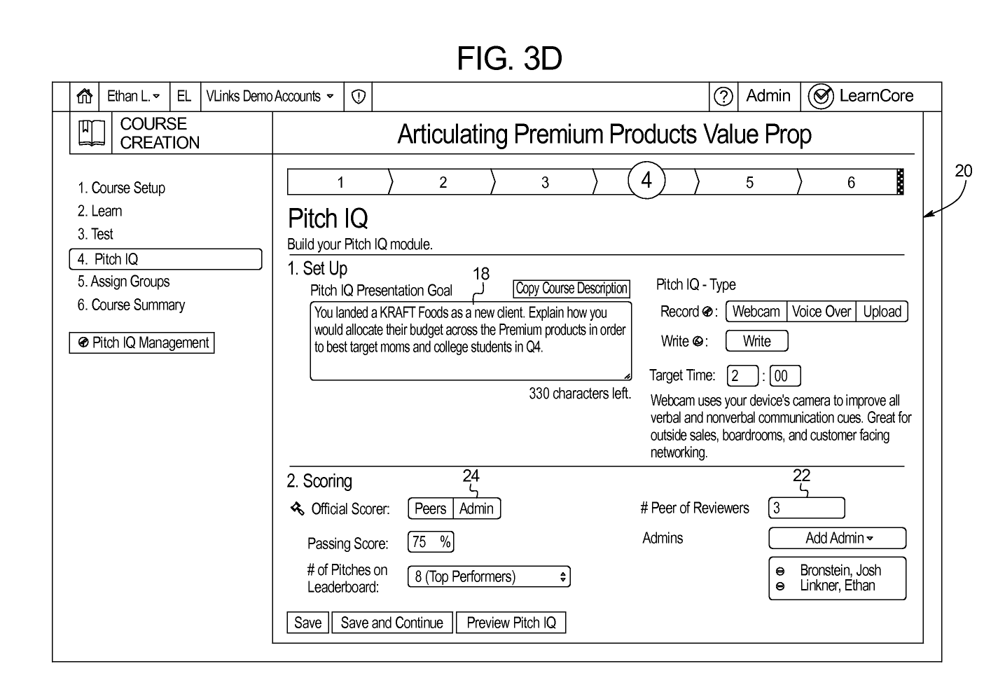

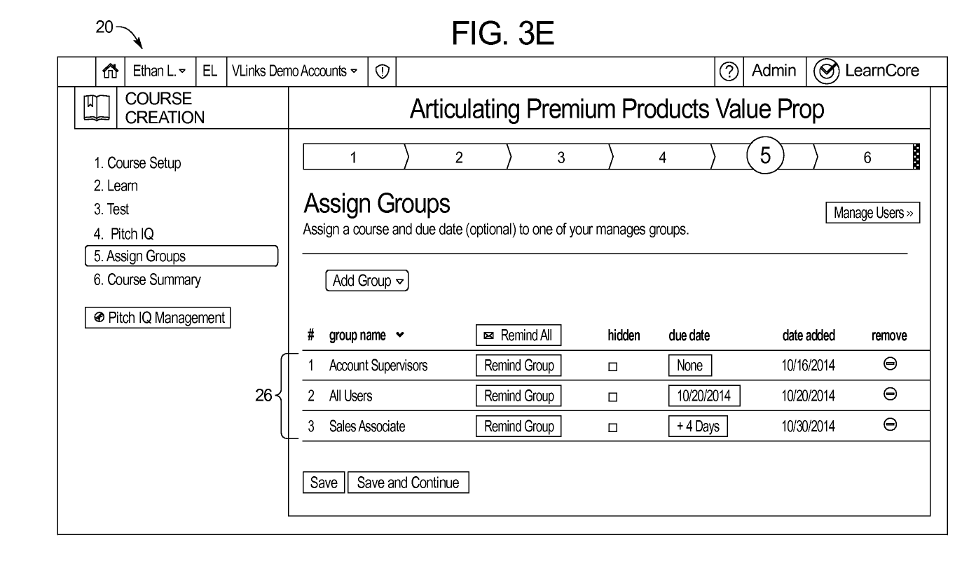

The pitch goal 18 may be communicated to the peers 22 in text form and/or with a recording. For example, the pitch goal 18 may be an audiovisual communication to the peer group 26 from the group leader 24 explaining the pitch goal 18. The group leader 24 may also indicate an evaluation criteria associated with the pitch goal 18, wherein the evaluation criteria outlines specific objectives for the communication to include, and/or a grading rubric. FIGS. 3A-3E illustrate front views of a user interface displaying a creation platform 20 of a pitch goal 18 by a group leader 24. The group leader 24 may input the type of pitch goal 18, a description of the pitch goal 18, the duration of the pitch goal 18, and the evaluation criteria under which the communication 30 will be scored, among other items.

Specifically, FIG. 3A includes an example of a group leader 24 setting up a course 38 including the course title and description. The group leader 24 may optionally include any prerequisites a peer 22 may be required to have completed prior to enrolling in the course. FIG. 3B depicts the creation of the course curriculum that is available in a learning module 42. FIG. 3C includes an optional creation of a test associated with the course 38. FIG. 3D is an example of a group leader 24 creating a pitch goal 18, as discussed above. FIG. 3E is an example of a group leader 24 assigning groups 26 to the created courses 38.

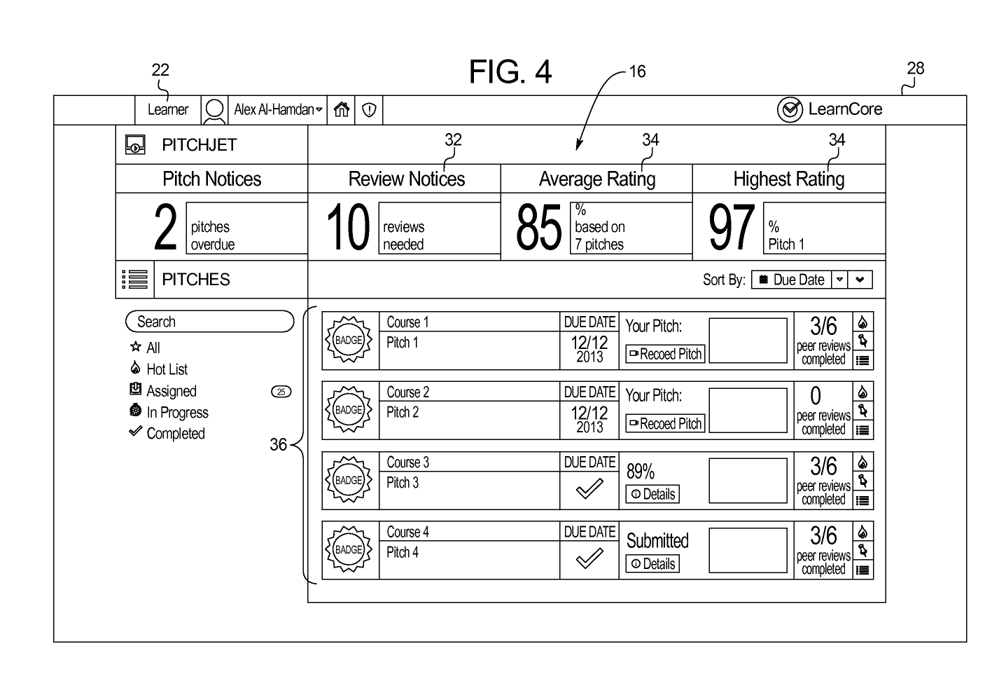

As shown in FIG. 4, each peer 22 may view their own individual peer profile module 16 that displays a number of pitch goals 18 the peer 22 needs to complete, the number of peer reviews 32 that the peer needs to complete, the peer score 34 (e.g., peer average score and peer highest scores), and a list of registered courses 36 the peer 22 must complete, among other items. For each course 36 listed the system 10 may display the course title, the due date of the pitch goal 18, a link to a communication module 38, whether or not the peer has submitted a communication 30, and the associated score 34 of the submitted communication 30, among other items.

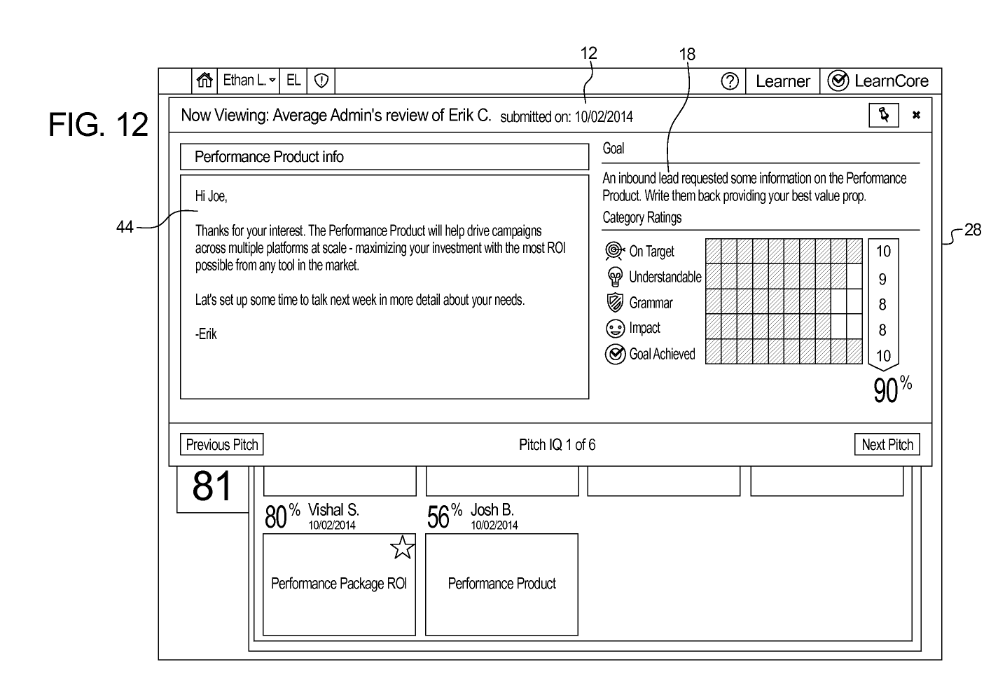

In the pitch module 12, each peer that is assigned a pitch goal may submit a communication 30 associated with the pitch goal 18. As shown in FIG. 1, the pitch module 12 enables peers to record a communication 30 associated with a pitch goal 18 in a record module 38. In addition, as shown in FIG. 12, the pitch module 12 enables peers to submit a written communication 30 associated with a pitch goal 18 in a writing module 44. The pitch module 12 may also be configured to receive a communication 30 that is a screen capture.

The pitch module 12 may be able to record and receive the communication 30 online. For example, the user interface may be configured for the learner to type the written communication 30, for example, directly into the system. Alternatively, the pitch module 12 may receive an uploaded communication 30 (such as a document or recording) that was recorded or written off line. The pitch module 12 may include a textual summary of the pitch goal 18, the target time length or word length of the communication 30, the number of peers 22 assigned to review the communication 30, and whether or not the peer 22 has submitted the communication 30. In an example, FIG. 1 depicts a user interface associated with the record module 38 for a communication 30.

In the example where the communication 30 is a recording, after a peer 22 records a communication 30 associated with the pitch goal 18, the user may re-record the pitch communication 30 until the peer 22 is satisfied with the pitch recording, and then submit the chosen communication 30 to the plurality of peers 22 and group leader 24 for evaluations. Similarly, in the writing module 44, a peer 22 may edit and resubmit the written communication 30 until the peer 22 is satisfied with the written communication 30. The peer 22 may submit a self-evaluation of the communication 30 in light of a pitch goal 18, and/or submit the communication 30 to a plurality of peers 22 and to the group leader 24 for evaluations.

The group leader 24 and plurality of peers 22 individually evaluate the communication 30 of the user based on a predefined set of criteria 55 within the pitch goal 18. The set of criteria 55 may include any suitable criteria 55. For example, the set of criteria 55 may include, yet not limited to, clarity, knowledge, confidence, enthusiasm, goal achieved, and/or grammar, among others.

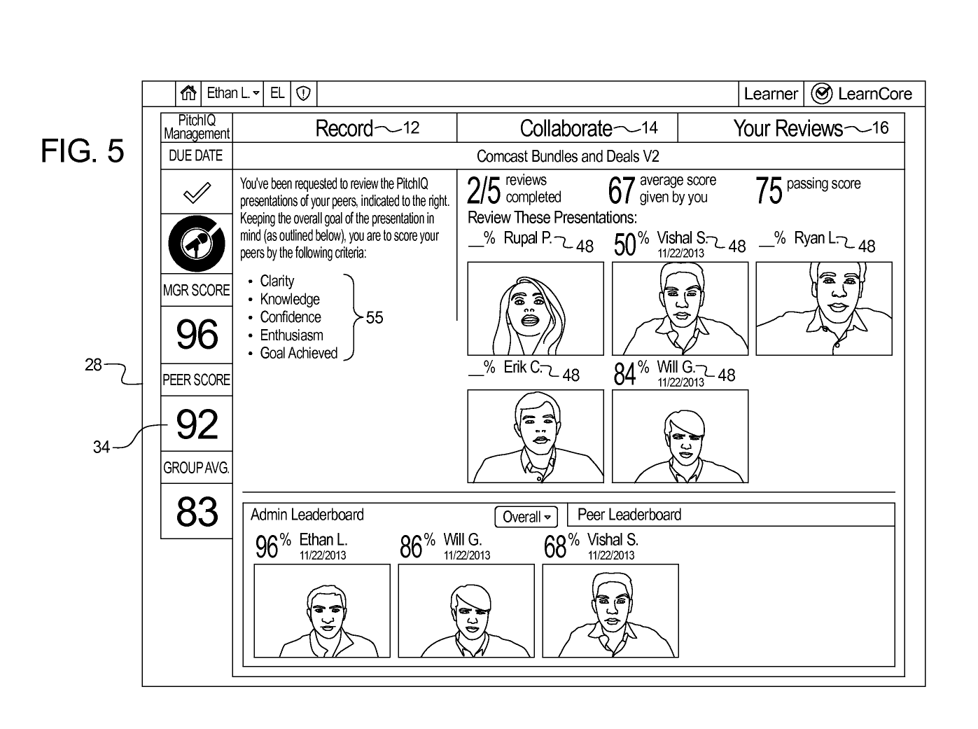

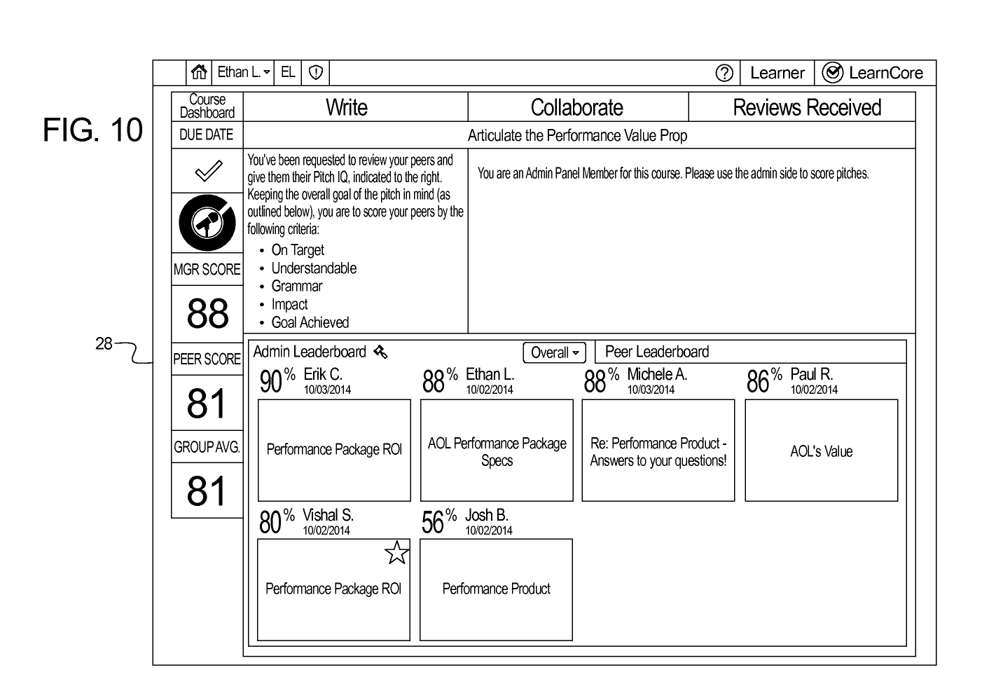

The evaluations 40 are submitted by the peers 22 and group leader 24 and the system 10 provides the individual scores 34 and/or a resulting accumulated score to the peer 22 associated with the communication 30 being evaluated. As shown in FIGS. 5 and 10, individual peer profile modules 16 may indicate the specific evaluations the peer 22 needs to perform.

For example, the peer 22 associated with the peer profile module 16 in FIG. 5 needs to review and evaluate three communications 30, as the peer 22 has already completed two peer reviews 32. For example, a reviewing party 46 (such as a particular peer 22 or group leader 24) may send a review request to the controller 50. Upon receiving the review request, the system 10 may be configured to retrieve a communication 30 from the database 54, wherein the review request is associated with a peer identification 48. In other words, the reviewing party 46 may submit a review request that includes a peer identification 48 associated with the communication 30 that the reviewing party 46 was assigned to review. The peer identification 48 may be a name, number, or any suitable identification associated with a peer 22 and/or communication 30.

The system 10 is also configured to retrieve the communication 30 associated with the peer identification 48 associated with the review request and display the retrieved communication on a user interface 28 associated with the reviewing party 46. The system 10 is also configured to receive or accept the submitted peer review 32 and store the peer review 32 in the database 54 according to the peer identification 48. The system 10 may also generate or update a score 34 associated with the peer identification 48 of the received peer review 32, wherein the score 34 is also stored within the database 54. The score 34 may be based on the quantitative and/or qualitative aspects of the peer review 32.

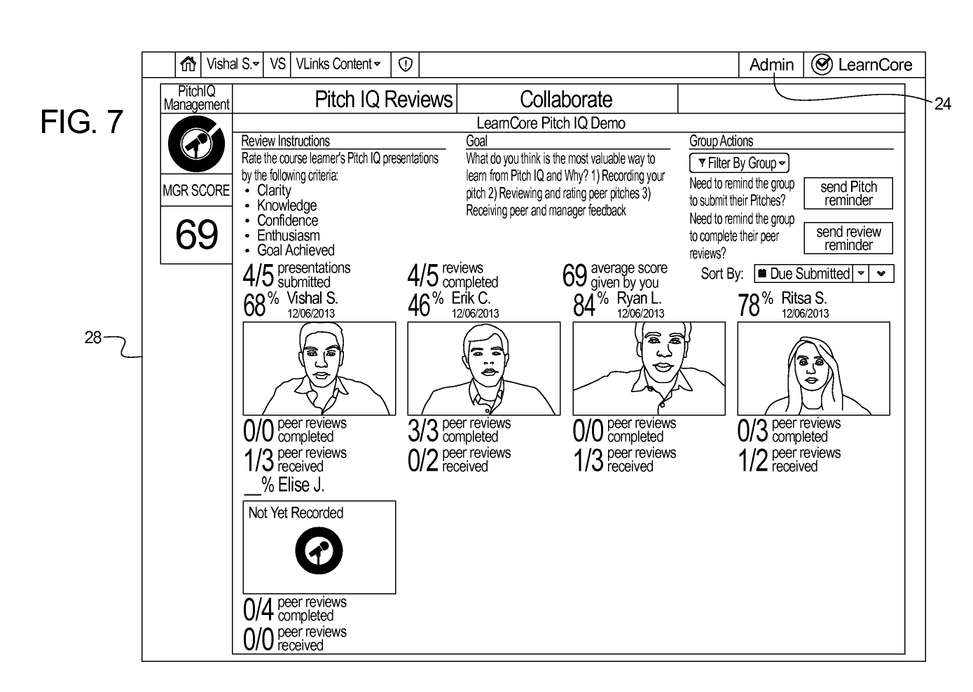

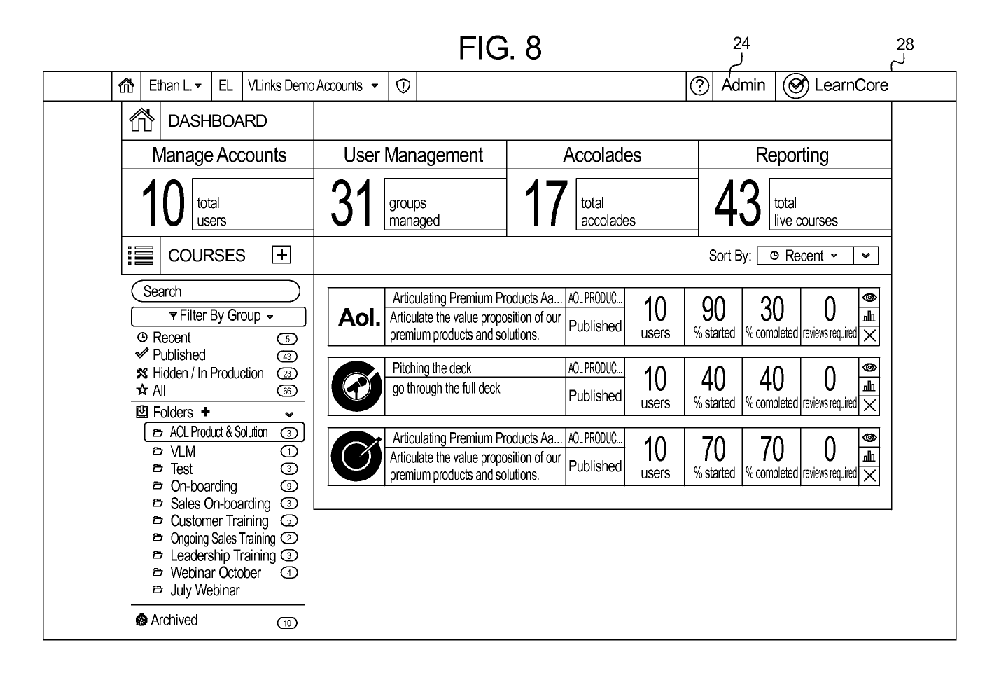

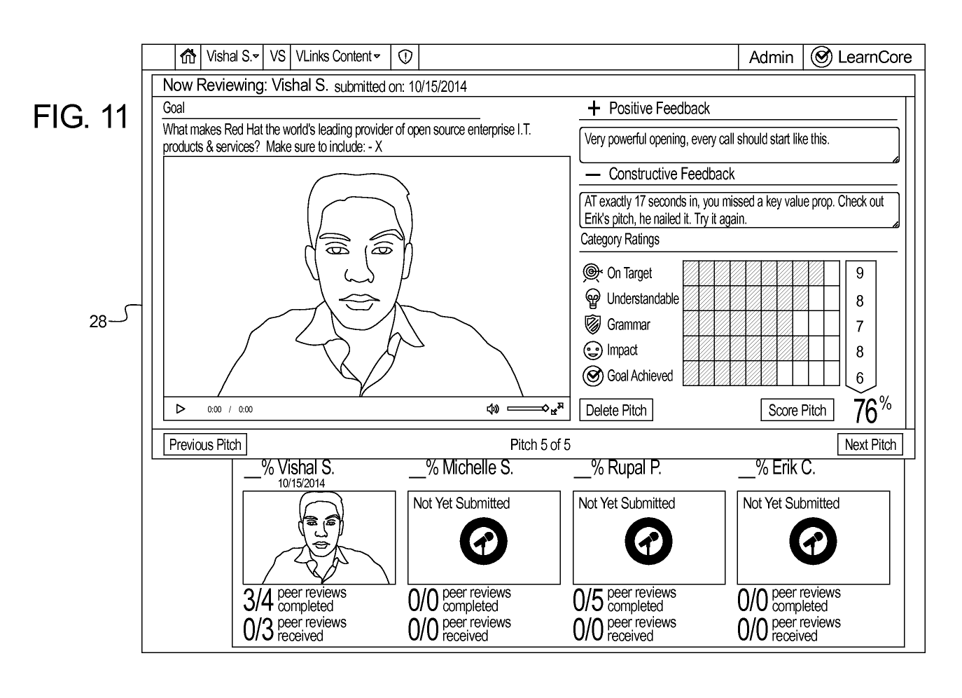

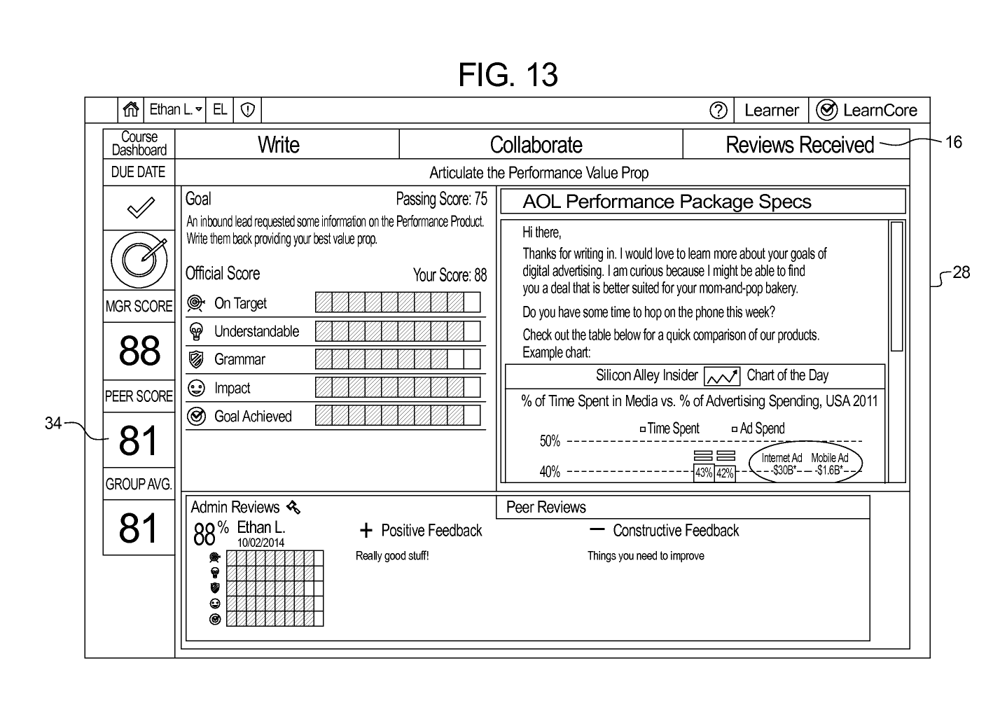

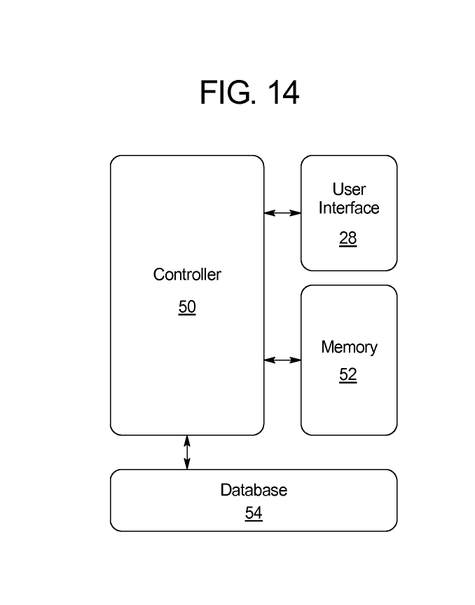

FIGS. 7-8 depict examples of peer profile modules 16 associated with a group leader 24, wherein the group leader 24 may view the peer scores 34 and/or peer reviews 32 submitted by reviewing parties 46. For example, as shown in FIG. 11, the group leader 24 may review the peer score 34 and peer reviews 32 associated with each peer 22 of the group 26 associated with the group leader 24. FIG. 13 depicts an example of a peer profile module 16 associated with a peer 22. As shown, the peer 22 has a peer score 34 of 81. Various other quantitative and qualitative feedback associated with peer 22 is provided in the peer profile module 16.

The system 10 can also include a learning module 42 that allows peers 22 to view training material. The training material may include text, audiovisual presentations, and live interactive web-based courses 36. For example, upon the system 10 generating a peer score 34 based on the peer reviews 32, the system 10 can recommend certain training material and/or courses 36 based on the received peer reviews 32 to improve the peer's communication skills. For example, if the peer 22 was determined deficient in body language based on the received peer reviews 32, the system 10 may automatically suggest a course 36 in the learning module 42 related to body language for the peer 22 to complete. In an example, upon the peer 22 completing the course 36 in the learning module 42, the system 10 may increase the peer's score 34. Furthermore, for sales departments specifically, the reporting system may also be linked to information that measures real work performance like customer relationship management (CRM) software. The linked CRM data may be used as an automatic recommendation for certain training.

The system 10 can also include a test module. For example, the test module may include text-based examinations for peers to complete, as shown in FIG. 3C. The text-based test may be any text-based format including multiple choice, true or false, open ended questions, among other types of questions. The testing material may be associated with various verbal and nonverbal communication skills. In an example, specific testing material may be associated with each training material within the learning module 42. For example, upon a peer completing training material associated with an elevator pitch, the system provides a link to testing material associated with an elevator pitch for the peer to complete. Submitted testing material may be scored by the system and the score may be incorporated into the peer score 34. Alternatively, the group leader 24 or peers 22 may score the testing material.

In an embodiment, the system 10 for measuring communication skills comprises a controller 50 and a memory 52 coupled to the controller 50, wherein the memory 52 is configured to store program instructions executable by the controller 50. In response to executing the program instructions, the controller 50 is configured to provide a pitch module 12, wherein the pitch module 12 is configured to receive a peer communication 30, and store the communication 30 in a database 54 including a plurality of communications 30 of associated peers 22.

The controller 50 is also configured to retrieve a communication 30 from the database 54, upon a review request from a reviewing party. The reviewing party may be a peer 22 or group leader 24. The retrieved recorded communication may be displayed on a user interface 28 associated with the reviewing party.

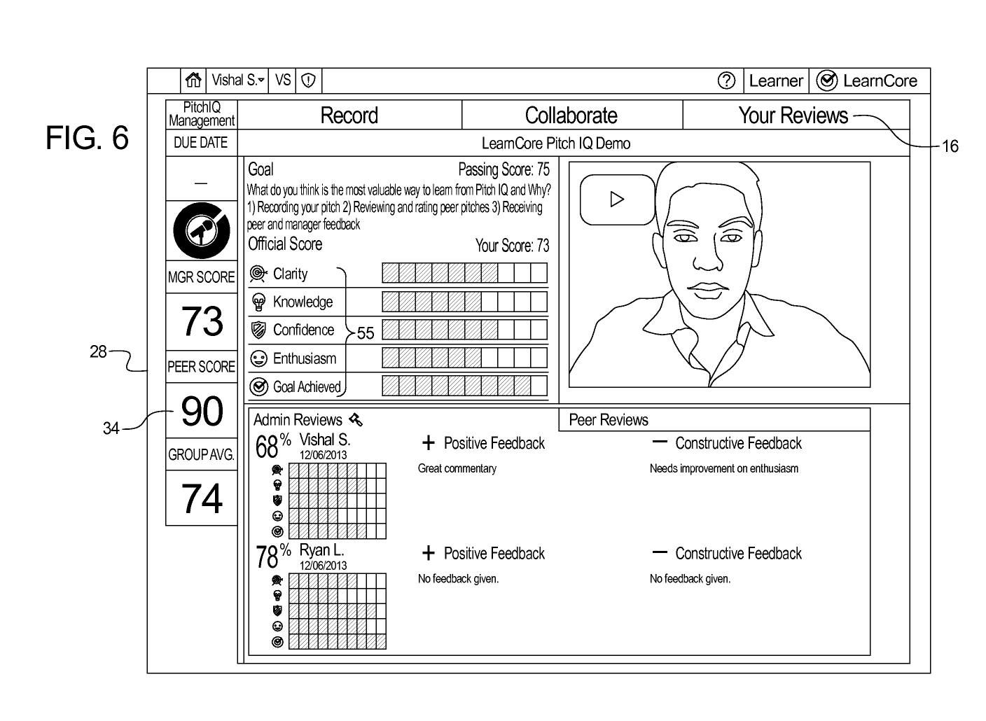

After viewing the communication 30, the reviewing party may complete and submit a peer review 32 of the retrieved communication 30. The controller 50 receives the submitted peer review 32 and stores the peer review 32 in the database, 54 wherein the peer review 32 is associated with a corresponding peer information. The peer 22 associated with the peer information may retrieve the peer review 32 and review the comments and scoring submitted by the reviewing party, as shown in FIG. 6. The peer review 32 may include at least one quantitative value assigned by the review party to the communication 30. Alternatively, or in addition, the peer review 32 may include at least one quantitative value associated with a plurality of predefined or customized review characteristics associated with the communication 30.

The controller 50 may also be configured to generate a score 34 associated with the peer information based on the peer review 32, wherein the score 34 is stored in the database 54. There may be a score 34 associated with each peer review 32, as well as an overall average score of a communication 30 determined by averaging all of the scores 34 associated with a particular communication 30. The average score of a peer 22 may be an average score of all of the communications 30 submitted by a particular peer 22. Alternatively, the peer score 34 may be calculated by an algorithm that calculates a peer score 34 based on various weighting of the submitted peer reviews 32 and/or submitted test material. In other words, the peer score 34 may not simply be an average of all of the received scores from the peer reviews 32 and/or testing material.

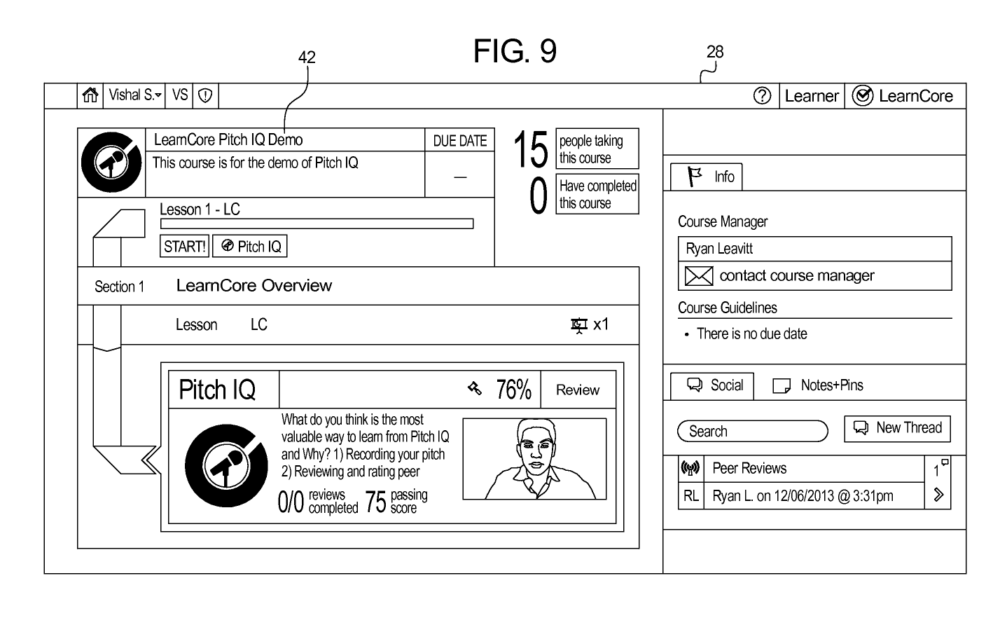

The system 10 may also include a learning module 42, wherein upon selection of the learning module 42, the controller 50 provides a peer 22 access to view learning information related to an associated learning topic. The learning topic may be any topic associated with verbal and non-verbal communication. In addition, the learning topic may be any substantive material, for example, the history of a company, an explanation of certain technology associated with a company, a lecture on a certain style of art, etc. In an example, FIG. 9 depicts a user interface displaying a learning module associated with Lesson 1-LC.

The system 10 may report information that allows group leaders 24 to match peers 22 with categorical deficiencies with peers 22 of higher proficiency, thus curating peer-to-peer learning within any group.

As mentioned above, one or more controllers 50 control aspects of the systems and methods described herein. The one or more controllers may be adapted to run a variety of application programs, access and store data, including accessing and storing data in the associated databases, and enable one or more interactions as described herein. Typically, the controller is embodied in one or more programmable data processing devices. The hardware elements, operating systems, and programming languages of such devices are conventional in nature, and it is presumed that those skilled in the art are adequately familiar therewith.

For example, the one or more controllers may be a PC based implementation of a central control processing system utilizing a central processing unit (CPU), memory and an interconnect bus. The CPU may contain a single microprocessor, or it may contain a plurality of microprocessors for configuring the CPU as a multi-processor system. The memory may include a main memory, such as a dynamic random access memory (DRAM) and cache, as well as a read only memory, such as a PROM, EPROM, FLASH-EPROM, or the like. The system may also include any form of volatile or non-volatile memory 52. In operation, the memory stores at least portions of instructions for execution by the CPU and data for processing in accord with the executed instructions.

The one or more controllers may also include one or more input/output interfaces for communications with one or more processing systems. Although not shown, one or more such interfaces may enable communications via a network, e.g., to enable sending and receiving instructions electronically. The communication links may be wired or wireless.

The one or more controllers 50 may further include appropriate input/output ports for interconnection with one or more output mechanisms (e.g., monitors, printers, touchscreens, motion-sensing input devices, etc.) and one or more input mechanisms (e.g., keyboards, mice, voice, touchscreens, bioelectric devices, magnetic readers, RFID readers, barcode readers, motion-sensing input devices, etc.) serving as one or more user interfaces for the controller. For example, the one or more controllers may include a graphics subsystem to drive the output mechanism. The links of the peripherals to the system may be wired connections or use wireless communications.

Although summarized above as a PC-type implementation, those skilled in the art will recognize that the one or more controllers also encompasses systems such as host computers, servers, workstations, network terminals, and the like. Further one or more controllers may be embodied in a device, such as a mobile electronic device, like a smartphone or tablet computer. In fact, the use of the term controller is intended to represent a broad category of components that are well known in the art.

Hence aspects of the systems 10 provided herein encompass hardware and software for controlling the relevant functions. Software may take the form of code or executable instructions for causing a controller or other programmable equipment to perform the relevant steps, where the code or instructions are carried by or otherwise embodied in a medium readable by the controller or other machine. Instructions or code for implementing such operations may be in the form of computer instruction in any form (e.g., source code, object code, interpreted code, etc.) stored in or carried by any tangible readable medium.

As used herein, terms such as computer or machine “readable medium” refer to any medium that participates in providing instructions to a processor for execution. Such a medium may take many forms. Non-volatile storage media include, for example, optical or magnetic disks, such as any of the storage devices in any computer(s) shown in the drawings. Volatile storage media include dynamic memory, such as the memory of such a computer platform. Common forms of computer-readable media therefore include for example: a floppy disk, a flexible disk, hard disk, magnetic tape, any other magnetic medium, a CD-ROM, DVD, any other optical medium, punch cards paper tape, any other physical medium with patterns of holes, a RAM, a PROM and EPROM, a FLASH-EPROM, any other memory chip or cartridge, or any other medium from which a controller can read programming code and/or data. Many of these forms of computer readable media may be involved in carrying one or more sequences of one or more instructions to a processor for execution.

It should be noted that various changes and modifications to the embodiments described herein will be apparent to those skilled in the art. Such changes and modifications may be made without departing from the spirit and scope of the present invention and without diminishing its attendant advantages. For example, various embodiments of the systems and methods may be provided based on various combinations of the features and functions from the subject matter provided herein.

We claim:

1. A system for measuring communication skills comprising:
a controller;
a memory coupled to the controller, wherein the memory is configured to store program instructions executable by the controller;
wherein in response to executing the program instructions, the controller is configured to:
provide a pitch module, wherein the pitch module is configured to receive a communication from a peer associated with a peer information;
store the received communication in a database including a plurality of communications, wherein each of the plurality of communications is associated with peer information;
retrieve a communication from the database, upon receiving a review request from a reviewing party, wherein the review request is associated with a peer identification;
display the retrieved communication on a user interface associated with the reviewing party;
accept a peer review of the retrieved communication from the user interface associated with the reviewing party;
store the peer review of the retrieved communication in the database, wherein the peer review is associated with the corresponding peer information, wherein the peer review may be retrieved by the peer associated with the peer information; and
generate a score associated with the peer information based on the peer review, wherein the score is stored in the database.

2. The system of claim 1 wherein the controller is further configured to provide a learning module, wherein upon selection of the learning module, the controller provides a peer access to view learning information related to an associated learning topic.

3. The system of claim 1 wherein the controller is further configured to provide a testing module, wherein upon selection of the testing module, the controller is configured to
display a text based test related to an associated testing topic;
receive test answers from a user interface associated with the peer information;
generate a test score based on the received test answers; and
update the peer score associated with the peer information based on the test score.

4. The system of claim 1 wherein the communication is an audio recording.

5. The system of claim 1 wherein the communication is an audio-visual recording.

6. The system of claim 1 wherein the communication is a writing sample.

7. The system of claim 1 wherein the communication is a screen capture.

8. The system of claim 1 wherein the reviewing party is selected from a group of peers associated with the peer information.

9. The system of claim 1 wherein the peer review includes at least one quantitative value assigned by the reviewing party to the communication.

10. The system of claim 1 wherein the peer review includes at least one quantitative value associated with a plurality of predefined review characteristics associated with the communication.

11. The system of claim 1 wherein, upon receiving predefined user information, the controller is configured to display a plurality of courses associated with the received user information.

12. A system for measuring communication skills comprising:
a controller;
a memory coupled to the controller, wherein the memory is configured to store program instructions executable by the controller;
wherein in response to executing the program instructions, the controller is configured to:
provide a pitch module, wherein the pitch module is configured to
receive a communication from a peer associated with a peer information,
store the received communication in a database including a plurality of communications, wherein each of the plurality of communications is associated with peer information;
provide an evaluation module, wherein the evaluation module is configured to
retrieve a communication from the database, upon receiving a review request from a reviewing party, wherein the review request is associated with a peer identification,
display the retrieved communication on a user interface associated with the reviewing party;
accept a peer review of the retrieved communication from the user interface associated with the reviewing party;
store the peer review of the retrieved communication in the database, wherein the peer review is associated with the corresponding peer information, wherein the peer review may be retrieved by the peer associated with the peer information;
generate a score associated with the peer information based on the peer review, wherein the score is stored in the database; and
provide a peer profile module associated with the peer identification, wherein the peer profile module is configured to
display on the user interface a plurality of peer reviews associated with the peer identification,
display on the user interface associated with the peer identification the score associated with the peer information.

13. The system of claim 12 wherein the communication is an audio recording.

14. The system of claim 12 wherein the communication is an audio-visual recording.

15. The system of claim 12 wherein the communication is a writing sample.

16. The system of claim 12 wherein the communication is a screen capture.
